(19) United States
(12) Patent Application Publication
(10) Pub. No.: US 2022/0070150 A1
(43) Pub. Date: Mar. 3, 2022

(54) PRIVACY-ENHANCED DATA STREAM COLLECTION

(71) Applicant: SAP SE, Walldorf (DE)

(72) Inventors: Martin Haerterich, Wiesloch (DE); Benjamin Weggenmann, Karlsruhe (DE); Florian Knoerzer, Karlsruhe (DE)

(21) Appl. No.: 17/010,501

(22) Filed: Sep. 2, 2020

(51) Int. Cl. H04L 29/06; G06F 21/62; G06N 3/04; G06N 3/08

(52) U.S. Cl. CPC H04L 63/0428; G06N 3/088; G06N 3/0454; G06F 21/6245

(57) ABSTRACT

Various examples are directed to systems and methods for obscuring personal information in a sensor data stream. A system may apply an encoder model to the sensor data stream to generate a latent space representation of the sensor data stream. The system may also apply a noise-scaling parameter to the latent space representation of the sensor data stream and apply a decoder model to the latent space representation of the sensor data stream to generate an obscured data stream.

### BRIEF DESCRIPTION OF DRAWINGS

The present disclosure is illustrated by way of example and not limitation in the following figures.

FIG. 1 is a diagram showing one example of an environment for implementing an encoder-decoder arrangement to obscure one or more sensor data streams.

FIG. 2 is a flowchart showing one example of a process flow that may be executed by the obscuring system to generate the obscured data stream.

FIG. 3 is a diagram showing one example implementation of an encoder-decoder arrangement utilizing a variational autoencoder.

FIG. 4 is a flowchart showing one example of a process flow that may be used to train the encoder-decoder arrangement of FIG. 3.

FIG. 5 is a diagram showing another example implementation of the variational autoencoder arrangement of FIG. 3.

FIG. 6 is a diagram showing one example implementation of an encoder-decoder arrangement that incorporates Fourier transform layers.

FIG. 7 is a block diagram showing one example of a software architecture for a computing device.

FIG. 8 is a block diagram of a machine in the example form of a computing system within which instructions may be executed for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

The wide proliferation of mobile computing devices, such as smart phones and connected wearables, has allowed users to enjoy a great many services that were not previously available. Many of these services utilize data streams generated by sensors onboard and/or in communication with a computing device. For example, data streams generated by a motion sensor can provide information about a user's activities including, the number of steps that the user takes, whether the user is running or walking, and so on. Motion sensors can also provide information about other human activities including sleep patterns, breathing rates, whether the user is standing or sitting, etc. Also, for example, data streams generated by a heart rate monitor or electrocardiogram (ECG) sensor can provide information about a user's heart health as well as activity levels.

Activity processing systems, sometimes referred to as Human Activity Recognition (HAR) systems, are programmed to analyze sensor streams describing user activities including, for example, motion sensor streams, heart rate sensor streams, breathing rate sensor streams, etc. Some activity processing systems are implemented locally, for example, at a user's mobile computing device. Locally-implemented activity processing systems can perform tracking and analysis for individual users. For example, a locally-implemented activity processing system may receive one or more sensor data streams describing a user and provide that user with information, diagnoses, or recommendations derived from the sensor stream or streams.

In some situations, however, it is desirable to analyze a user's sensor data streams in conjunction with similar sensor data streams describing a peer group of users. For example, results of an activity processing system may be used to draw conclusions about a particular cohort of users such as, for example, how often the cohort performs a certain activity and for how long. In another example, an activity processing system may use or create a computerized model that is trained using training data received from multiple users. Such a computerized model can then be used, for example, for diagnoses and other purposes when analyzing a user's sensor data stream or streams.

When an activity processing system uses sensor data streams received from multiple users, however, privacy concerns are implicated. For example, sensor data streams received from a human user may reveal the identity the human user. This can occur even if the sensor data stream is stripped of personal identifiers, such as the user's name, location, etc. For example, even a user's unique gait could be detected from a motion sensor data stream, and other unique traits may also be used to uniquely identify a particular user.

The privacy implications of sensor data streams affect the operation of activity processing systems in numerous ways. For example, users may be reluctant to provide sensor data streams without assurances that the users themselves will not be identifiable from the data. When users are reluctant to share sensor data streams, the quality of the resulting processing may suffer. For example, user reluctance to provide data may cause activity processing systems to train computerized models using smaller and/or less representative training data sets. Also, some jurisdictions have enacted laws that protect user privacy by preventing the use of user data that can be used to identify the user.

Various examples address these and other problems by obscuring one or more sensor data streams using an encoder-decoder arrangement. In an encoder-decoder arrangement, sometimes referred to as an autoencoder, an encoder model receives a sensor data stream and transforms the sensor data stream from a feature space to a latent space, resulting in a latent space representation of the sensor data stream. The latent space representation is provided to a decoder model. The decoder model is trained to convert the latent space representation back to the feature space, generating an obscured data stream that is a recreation of the original sensor data stream.

An encoder-decoder arrangement obscures the sensor data stream due to the lossy nature of the encoder model. The latent space representation of a sensor data stream generated by the encoder model has a lower dimensionality than the sensor data stream itself. For example, the dimensionality of a time series, such as the sensor data stream, is based on the number of quantities measured and the number of time samples in the series. The latent space representation generated by the encoder may be or include a state vector, where the state vector has a lower dimensionality than the sensor data stream. Accordingly, the encoder model acts as lossy compression function. By reducing the dimensionality of the sensor data stream, the encoder mode causes the loss of information from the sensor data stream. The lost information is not recovered by the decoder. As a result, the encoder-decoder system may reduce distinctive patterns included in a sensor data stream that might uniquely identify the associated user without destroying the usefulness of the obscured data stream to an activity processing system.

In some examples, an encoder-decoder arrangement, as described herein, also utilizes one or more noise-scaling parameters. A noise-scaling parameter is applied to the latent space representation and, thereby, may be a parameter of the encoder-decoder arrangement (e.g., of an autoencoder comprising the encoder model and the decoder model). A noise-scaling parameter, in some examples, is a scalar that is applied to the to the latent space representation using scalar or component-wise multiplication or any other suitable technique. Applying one or more noise-scaling parameters to the latent space representation adds uncertainty or noise to the resulting obscured data stream. The uncertainty or noise may reduce or obscure any distinctive patterns included in the sensor data stream that might uniquely identify the associated user without destroying the usefulness of the obscured data stream to an activity processing system.

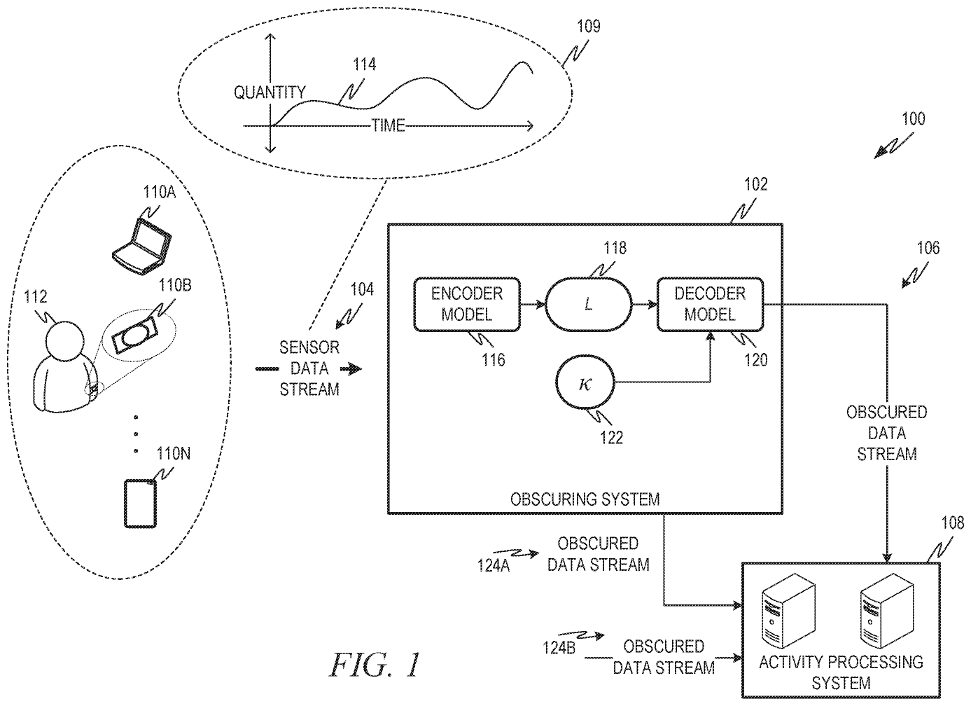

FIG. 1 is a diagram showing one example of an environment 100 for implementing an encoder-decoder arrangement to obscure one or more sensor data streams. The environment includes an obscuring system 102. The obscuring system 102 receives a sensor data stream 104 and generates a corresponding obscured data stream 106. The obscured data stream 106 is provided to an activity processing system 108. The activity processing system 108 uses the obscured data stream to perform various tasks including, for example, training one or more computerized models, drawing conclusions about a cohort of users, etc. The obscured data stream 106 omits data or data patterns that uniquely identify the user 112 described by the sensor data stream 104.

The sensor data stream 104 is generated using one or more mobile computing devices 110A, 110B, 110N. The mobile computing devices 110A, 110B, 110N may be or include any suitable computing devices including, for example, desktop computers, laptop computers, tablet computers, wearable computers, etc. In the example of FIG. 1, the mobile computing device 110A is depicted as a laptop computer; the mobile computing device 110B is depicted as a wearable computing device; and the mobile computing device 110N is depicted as a mobile phone. It will be appreciated that the user 112 may utilize one or more other mobile computing device not shown in FIG. 1 in addition to or instead of the example device or devices shown.

FIG. 1 illustrates an example representation 109 of the sensor data stream 104. The representation 109 indicates a TIME axis and a QUANTITY axis with a curve 114 plotted thereon. The QUANTITY axis indicates a quantity measured by a sensor at a mobile computing device 110A, 110B, 10N. The TIME axis indicates the time at which the sensor was sampled. The curve 114 indicates sensor values generated by a sensor at a mobile computing device 110A, 110B, 110N.

In some examples, the sensor data stream 104 may include multiple quantity dimensions. A sensor data stream 104 may include more than one quantity dimension, for example, if it is based on a sensor that generates a multidimensional output. Consider an example accelerometer that generates an output indicating the acceleration of the sensor in each of three spatial dimensions. Such an accelerometer may generate a sensor data stream having three quantities versus time (e.g., acceleration in the x direction, acceleration in the y direction, and acceleration in the z direction). Consider also an example gyroscopic sensor that generates a data stream also having three quantities versus time (e.g., roll, pitch, and yaw).

In some examples, the outputs of multiple sensors are combined to generate a single sensor data stream 104 with multiple quantity dimensions. Consider an example mobile computing device 110A, 110B, 110N including a geographic positioning system, a heart rate or ECG sensor, a respiratory sensor, and a muscle oxygen sensor. Such a mobile computing device 110A, 110B, 110N may generate a single sensor data stream 104 that includes a quantity dimension for the output of each of the sensors.

Although multiple mobile computing devices 11A, 110B, 110N are shown in FIG. 1, it will be appreciated that a single mobile computing device 110A, 110B, 110N may be used to generate the sensor data stream 104, in some examples. Also, in some examples, multiple mobile computing devices 110A, 110B, 110N may be used in conjunction to generate the sensor data stream 104. For example, different mobile computing devices 110A, 110B, 110N may include different sensors, where outputs from the different sensors are merged to form the sensor data stream 104 as described herein. In another example arrangement, a mobile computing device 110A, 110B, 110N, such as the wearable computing device, includes one or more sensors and provides outputs of the one or more sensors to a second mobile computing device 110A, 110B, 110N. The second mobile computing device 110A, 110B, 110N provides a corresponding sensor data stream 104 to the obscuring system 102 and/or activity processing system 108.

The obscuring system 102 receives the sensor data stream 104 and generates an obscured data stream 106. The obscuring system 102, in some examples, comprises one or more computing devices that are distinct from the mobile computing devices 110A, 110B, 110N and from the activity processing system 108. In other examples, the obscuring system 102 is implemented by one or more of the mobile computing devices 110A, 110B, 110N and/or by the activity processing system 108. For example, some or all of the obscuring system 102 may execute at a processor of the mobile computing device 110A, 110B, 110N and/or at a processor of the activity processing system 108.

The obscuring system 102 implements an encoder-decoder arrangement. An encoder model 120 receives the sensor data stream 104 and generates a corresponding latent space representation 118. As described herein, the conversion of the sensor data stream 104 to the latent space representation 118 may be a lossy compression. Accordingly, the latent space representation 118 may have a smaller dimensionality than the sensor data stream 104. The latent space representation 118 is provided to a decoder model 120. The decoder model 120 generates the obscured data stream 106 using the latent space representation 118. In some examples, one or more noise scaling parameters 122 are applied to the latent space representation 118. In some examples, the noise-scaling parameter 122 is a scalar that is applied to the latent space representation 118, for example, using multiplication.

The obscured data stream 106 is provided to the activity processing system 108. The activity processing system 108 may receive additional obscured data streams 124A, 124B in addition to the obscured data stream 106. The additional obscured data streams 124A, 124B may be received from users other than the user 112. In the example of FIG. 1, the obscured data stream 124A is received from the obscuring system 102 and the obscured data stream 124B is received from another obscuring system 102 (not shown in FIG. 1). In various examples, however, obscured data streams 106, 124A, 124B can be received from one obscuring system 102 and/or from multiple obscuring systems.

The activity processing system 108 may perform various processing tasks using the obscured data stream 106. In some examples, the activity processing system 108 utilizes the obscured data streams 106, 124A, 124B to recognize physical activity, such as exercise or other physical activity of the user 112 and other users described by the streams 106, 124A, 124B. The activity processing system 108 may utilize recognized or detected physical activities to perform fitness tracking, diabetes prevention, or another suitable task. For example, the activity processing system 108 may be programmed to send an alert to the user 112 or other users if the user's activities indicate a risk for diabetes or other condition.

In another example, the activity processing system 108 utilizes the obscured data streams 106, 124A, 124B to monitor the cardiovascular activity of the user 112 and/or other users including, for example, monitoring heart rate, heart rate variability, or other factors. In another example, the activity processing system 108 utilizes the obscured data streams 106, 124A, 124B to monitor the pulmonary health of the user 112 or other users. In yet another example, the activity processing system 108 utilizes the obscured data streams 106, 124A, 124B to monitor coordinative and motor skills of the user or other users. For example, the activity processing system 108 may detect Parkinson's disease or similar diseases based on the coordinative and/or motor skills. In another example, the activity processing system 108 utilizes the obscured data streams 106, 124A, 124B to monitor sleep quality for the user 112 and other users.

In examples where the activity processing system 108 is configured to generate computer models utilizing the various obscured data streams 106, 124A, 124B. For example, the obscured data streams 106, 124A, 124B may be used as training data for training a computerized model. The trained computerized model may be a classifier that is applied to an obscured data stream 106, 124A, 124B to detect a condition such as, for example, a risk of diabetes, Parkinson's disease, heart disease etc. The trained computerized model may be applied by the activity processing system 108 and/or may be provided to one or more mobile computing devices 110A, 110B, 110N to be applied directly to a sensor data stream, such as the sensor data stream 104.

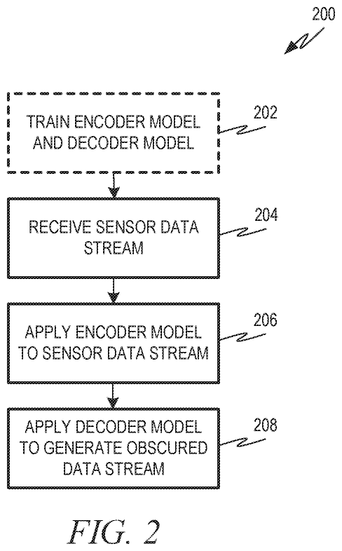

FIG. 2 is a flowchart showing one example of a process flow 200 that may be executed by the obscuring system 102 to generate the obscured data stream 106. At optional operation 202, the obscuring system 102 trains the encoder model 116 and the decoder model 120. Operation 202 may be executed when the models 116, 120 are or include trained machine-learning models, such as deep neural networks. For example, the models 116, 120 may be trained together as a variational autoencoder (VAE). The obscuring system 102 may train the models 116 using training data, where the training data comprises a training sensor data stream. The training sensor data stream may be the sensor data stream 104 or another suitable sensor data stream.

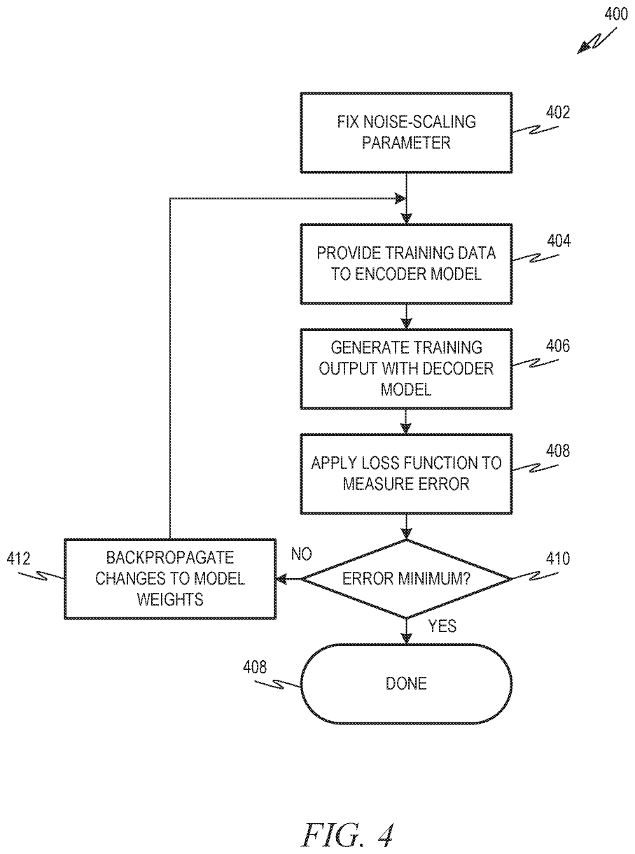

The obscuring system 102 provides the training sensor data stream to the encoder model 116 to generate a training latent space representation. The training latent space representation is provided to the decoder model 120, for example, with any noise-scaling parameters set to a fixed value, such as unity. The output of the decoder model 120 is compared to the training sensor data stream. Deviations between the output of the decoder model 120 and the training sensor data stream are back-propagated to the weights of the encoder model 116 and decoder model 120 in order to lower the measured deviation. This process may be iterated multiple times with the parameters of the models 116, 120 optimized at each iteration. Training may be complete with the deviation between the training sensor data stream and the output of the decoder model 120 is less than a threshold amount. An additional example for training the encoder model 116 and decoder model 120 is provided herein with respect to FIG. 4

At operation 204, the obscuring system 102 receives the sensor data stream 104. In examples in which the obscuring system 102 is implemented as a stand-alone system and/or by the activity processing system 108, the sensor data stream 104 may be received from a mobile computing device 110A, 110B. 110N. In examples in which the obscuring system 102 is implemented by a mobile computing device 110A, 110B, 110N, the sensor data stream 104 may be received from a sensor (e.g., via an operating system, memory, or other component).

At operation 206, the obscuring system 102 applies the encoder model 116 to the sensor data stream 104 to generate the latent space representation 118 of the sensor data stream 104. Optionally, one or more noise scaling parameters are applied to the latent space representation 118 as described herein. At operation 208, the obscuring system 102 applies the decoder model 120 to the latent space representation 118 to generate the obscured data stream 106.

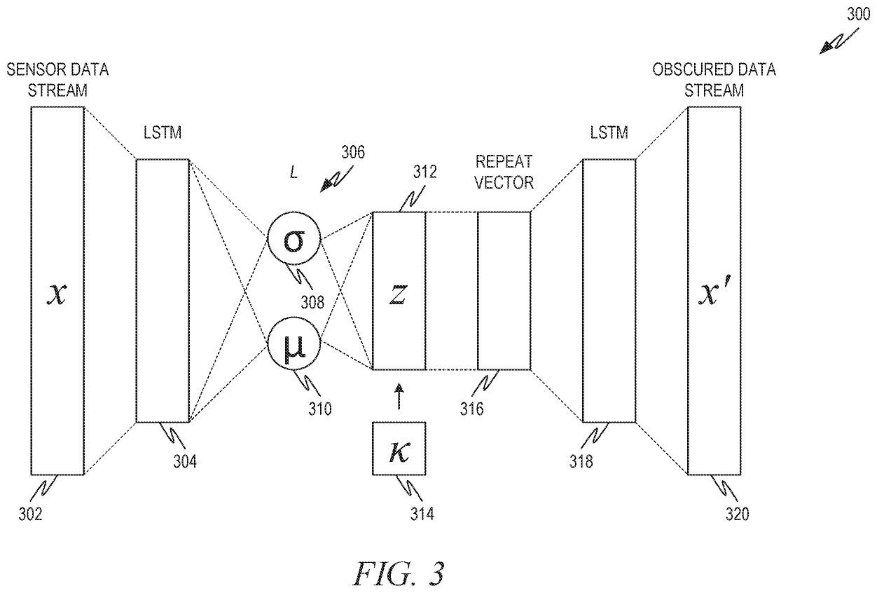

FIG. 3 is a diagram 300 showing one example implementation of an encoder-decoder arrangement utilizing a variational autoencoder. In the example of FIG. 3, an encoder model 304 and decoder model 318 are recurrent neural networks (RNN). For example, the encoder model 304 and decoder model 318 may be Long-Sort-Term Models (LSTMs), Gated Recurrent Unit (GRU) models or any other sort of RNN. Also, in some examples, other types of computerized models may be used such as, for example, other types of neural networks. A sensor data stream 302 (also indicated by x) is provided to the encoder model 304, which generates a latent space representation 306. In this example, the latent space representation 306 is a state vector including a mean 310 (indicated by μ) and variance 308 (indicated by a) output of the encoder model 304. In this way, the latent space representation 306 represents a probability distribution of the sensor data stream 302.

In this example, the latent space representation 306 is used to generate a sampled data stream 312 (indicated by z). For example, the sampled data stream 312 may be sampled from a Gaussian distribution with a mean corresponding to the mean 310, and a variance that is a function of the variance 308. In some examples, the noise-scaling parameter 314 (indicated by κ) is applied as a term of the function ƒ_{κ} of the variance 308. The function ƒ_{κ} may be an increasing function in κ for a fixed variance σ. An example of the function ƒ_{κ} is given by Equation [1] below, although other forms are contemplated as well:

ƒ_{κ}(σ)=κ [1]

The sampled data stream 312 is prepended by a repeat-vector layer 316 to generate a series input. The series input is provided to the decoder model 318, which generates the obscured data stream 320 (indicated by x′).

FIG. 4 is a flowchart showing one example of a process flow 400 that may be used to train the encoder-decoder arrangement of FIG. 3. At operation 402, the value of the noise-scaling parameter is fixed. For example, the value of the noise-scaling parameter 314 is set to a fixed value, such as unity or one. At operation 404, training data is provided to the encoder model 304. The training data may include one or more sensor data streams.

At operation 406, the encoder model 304 and decoder model 318 are used to generate a training output data stream. For example, the encoder model 304 generates a latent space representation 306 of the training data. A sampled data stream 312 is generated using the latent space representation 306 of the training data. The sampled data stream 312 is prepended by the repeat-vector layer 316 to generate a series input provided to the decoder model 318 to generate a decoder model output.

At operation 408, a loss function is applied to the measure a deviation between the training data and the training output. Any suitable loss function may be used such as, for example, a Euclidian error loss function, a mean squared error, a Kullback-Leibler divergence, etc. In some examples, the total loss used for training can be a combination of more than one loss measurement. For example, the total loss, in some examples, is equal to a reconstruction of a loss between the input and output time series plus a Kullback-Leibler divergence between the standard normal distribution and normal distribution modeled by the mean 310 and variance 308 of the latent space representation 306.

At operation 410, it is determined whether the error determined at operation 408 is sufficiently small such as, for example, at a minimum. If the error is at a minimum, then the training is complete at operation 408. If the error is not at a minimum, then changes to the weights of the encoder model 304 and decoder model 318 are backpropagated at operation 412 and training data is again provided at operation 404.

In some examples, the loss function used at operation 408 is determined utilizing a maximum-mean discrepancy (MMD) between an actual latent distribution, indicated by the mean 310 and variance 308 and a desired latent distribution. For example, the desired latent distribution may be or include a multidimensional, symmetric standard such as a Gaussian distribution with a mean of zero and a variance of 1. In another example, the desired latent distribution may be a bounded probability distribution having a constant density.

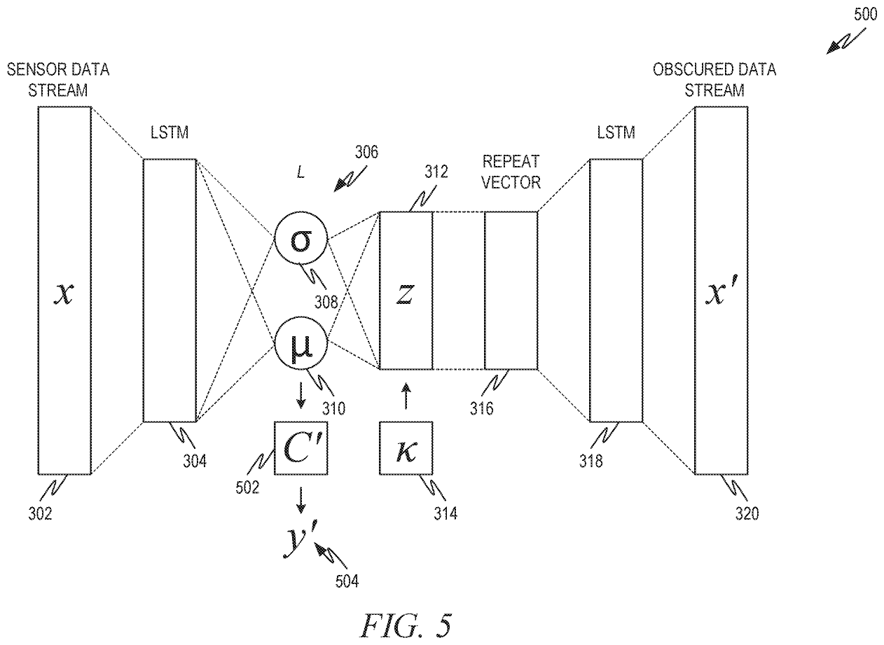

FIG. 5 is a diagram 500 showing another example implementation of the variational autoencoder arrangement of FIG. 3. In the example of FIG. 5, one or more additional terms are applied to the latent space representation 306. In the example of FIG. 5, a classifier 502 (indicated by C^{η}). The classifier 502 is a computerized model that is trained to take the latent space representation 306 as an input and provide an output 504 (indicated by y^{t}) indicating a state of the user described by the input data stream 302. For example, the classifier 502 may be trained to identify and/or characterize an activity of the user indicated by the input data stream 302. In some examples, the classifier 502 is trained to perform a task that the activity processing system will perform on the obscured data stream.

The loss function of the classifier 502 may be applied to the latent representation 306 to bias the latent representation 306 to a format that is more likely to be related to the task to be performed on the obscured data stream 320 by the activity processing system. For example, the loss function of the classifier 502 may indicate a change or variance in the step frequency of the encoder sampled data stream 312, a maximum or minimum of the sensor data stream 302 over time, a steepness of curves indicating certain parameters, etc.). The loss indicated by the loss function of the classifier 502 may be back-propagated through the latent representation 306 and encoder 304 to influence their weights and, thereby, bias the obscured data stream 320.

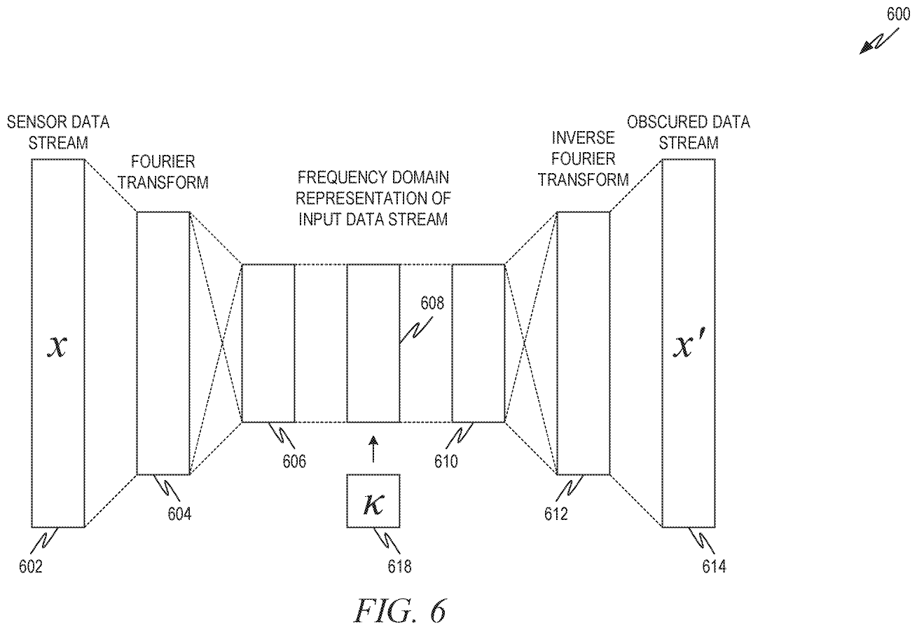

FIG. 6 is a diagram 600 showing one example implementation of an encoder-decoder arrangement that incorporates Fourier transform layers. In the example arrangement of FIG. 6, a Fourier transform layer 604 is applied before data is provided to a neural network encoder model 606. The layer or layers of the encoder model 606 may be fully connected. The output of the encoder model 606 is a latent space representation 608. The latent space representation 608 is provided to a decoder model 610 that may comprise one or more fully connected neural network layers, with the output provided to an inverse Fourier transform layer 612.

The Fourier transform layer 604 applies a Fourier transform to the sensor data stream 602 (indicated by x), resulting in a frequency domain representation of the sensor data stream 602. Any suitable technique or algorithm may be used to apply the Fourier transform such as, for example, a fast Fourier transform (FFT), a discrete Fourier transform (DFT), etc. In this example, the sensor data stream 602 may be a fixed-length input sequence. The frequency domain representation of the sensor data stream 602 may be provided to the encoder model 606 as described. The output of the encoder model 606 may be the latent space representation 608. One or more noise-scaling parameters 618 may be applied to the latent space representation 608.

The latent space representation 608 is provided to the decoder model 610. An output of the decoder model 610 is provided to the inverse Fourier layer 612, which generates the obscured data stream 614 (indicated by x′) in the time domain. In some examples, the arrangement of FIG. 6 may also include a classifier, similar to the classifier 502. A loss function of the classifier may be applied to the frequency domain latent space representation 608 prior to application of the inverse Fourier transform by the decoder model 603. The arrangement of FIG. 6 may be trained, in some examples, as described herein including, for example, as described with respect to FIG. 4.

### EXAMPLES

Example 1 is a system for obscuring personal information in a sensor data stream, the system comprising: a computing device comprising at least one processor and an associated storage device, the at least one processor programmed to perform operations comprising: applying an encoder model to the sensor data stream to generate a latent space representation of the sensor data stream; applying a noise-scaling parameter to the latent space representation of the sensor data stream; and applying a decoder model to the latent space representation of the sensor data stream to generate an obscured data stream.

In Example 2, the subject matter of Example 1 optionally includes wherein the noise-scaling parameter is a parameter of the decoder model.

In Example 3, the subject matter of any one or more of Examples 1-2 optionally includes wherein the latent space representation of the sensor data stream comprises a state vector, the state vector describing a mean and a variance.

In Example 4, the subject matter of Example 3 optionally includes wherein the noise-scaling parameter comprises a scalar, and wherein applying the noise-scaling parameter to the latent space representation of the sensor data stream comprises applying the scalar to the state vector.

In Example 5, the subject matter of any one or more of Examples 3-4 optionally includes the operations further comprising sampling a distribution having with a mean equal to the mean of the state vector and a variance that is a function of the variance of the state vector and the noise-scaling parameter, the sampling to generate a sampled data stream, wherein an input to the decoder model is based at least in part on the sampled data stream.

In Example 6, the subject matter of any one or more of Examples 1-5 optionally includes the operations further comprising training the encoder model and the decoder model using a training data set and a loss function.

In Example 7, the subject matter of Example 6 optionally includes the operations further comprising: accessing maximum-mean discrepancy (MMD) data describing a maximum-mean discrepancy between the latent space representation of the sensor data stream and a desired latent distribution of the sensor data stream; and determining the loss function using the MMD data and the latent space representation of the sensor data stream.

In Example 8, the subject matter of any one or more of Examples 6-7 optionally includes the operations further comprising: accessing Kullback-Leibler data describing a Kullback-Leibler divergence between the latent space representation of the sensor data stream and a desired latent distribution of the sensor data stream; and determining the loss function using the Kullback-Leibler data and the latent space representation of the sensor data stream.

In Example 9, the subject matter of any one or more of Examples 1-8 optionally includes a Fourier transform layer, and wherein the latent space representation of the sensor data stream is based at least in part on a frequency-domain representation of the sensor data stream.

Example 10 is a method for obscuring personal information in a sensor data stream, the method comprising: applying, using at least one processor, an encoder model to the sensor data stream to generate a latent space representation of the sensor data stream; applying, using the at least one processor, a noise-scaling parameter to the latent space representation of the sensor data stream; and applying, using the at least one processor, a decoder model to the latent space representation of the sensor data stream to generate an obscured data stream.

In Example 11, the subject matter of Example 10 optionally includes wherein the noise-scaling parameter is a parameter of an autoencoder model comprising the encoder model the decoder model.

In Example 12, the subject matter of any one or more of Examples 10-11 optionally includes wherein the latent space representation of the sensor data stream comprises a state vector, the state vector describing a mean and a variance.

In Example 13, the subject matter of Example 12 optionally includes wherein the noise-scaling parameter comprises a scalar, and wherein applying the noise-scaling parameter to the latent space representation of the sensor data stream comprises applying the scalar to the state vector.

In Example 14, the subject matter of any one or more of Examples 12-13 optionally includes sampling a distribution having with a mean equal to the mean of the state vector and a variance that is a function of the variance of the state vector and the noise-scaling parameter, the sampling to generate a sampled data stream, wherein an input to the decoder model is based at least in part on the sampled data stream.

In Example 15, the subject matter of any one or more of Examples 10-14 optionally includes training the encoder model and the decoder model using a training data set and a loss function.

In Example 16, the subject matter of Example 15 optionally includes accessing maximum-mean discrepancy (MMD) data describing a maximum-mean discrepancy between the latent space representation of the sensor data stream and a desired latent distribution of the sensor data stream; and determining the loss function using the MMD data and the latent space representation of the sensor data stream.

In Example 17, the subject matter of Example 16 optionally includes accessing Kullback-Leibler data describing a Kullback-Leibler divergence between the latent space representation of the sensor data stream and a desired latent distribution of the sensor data stream; and determining the loss function using the Kullback-Leibler data and the latent space representation of the sensor data stream.

In Example 18, the subject matter of any one or more of Examples 10-17 optionally includes applying a Fourier transform to the sensor data stream, and wherein the latent space representation of the sensor data stream is based at least in part on a frequency-domain representation of the sensor data stream.

Example 19 is a non-transitory machine-readable medium comprising instructions thereon that, when executed by at least one processor, causes the at least one processor to perform operations comprising: applying an encoder model to a sensor data stream to generate a latent space representation of the sensor data stream; applying a noise-scaling parameter to the latent space representation of the sensor data stream; and applying a decoder model to the latent space representation of the sensor data stream to generate an obscured data stream.

In Example 20, the subject matter of Example 19 optionally includes wherein the noise-scaling parameter is a parameter of an autoencoder model comprising the encoder model and the decoder model.

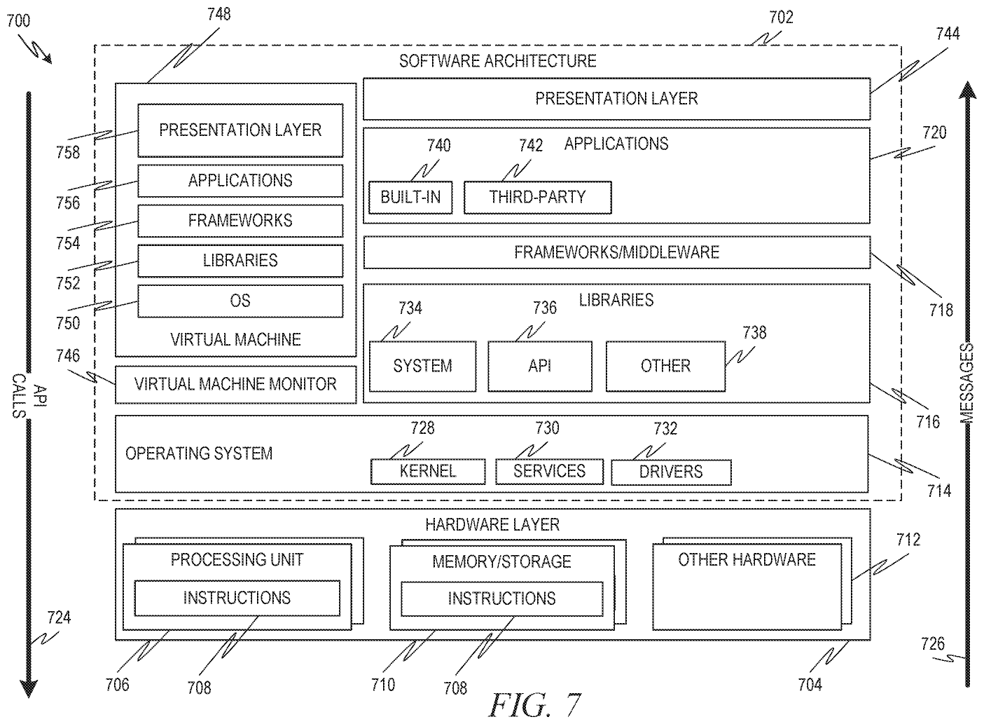

FIG. 7 is a block diagram 700 showing one example of a software architecture 702 for a computing device. The architecture 702 may be used in conjunction with various hardware architectures, for example, as described herein. FIG. 7 is merely a non-limiting example of a software architecture and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system of FIG. 7.

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware as indicated by other hardware 712 which represents any other hardware of the hardware layer 704, such as the other hardware illustrated as part of the software architecture 702.

In the example architecture of FIG. 7, the software architecture 702 may be conceptualized as a stack of layers where each layer provides particular functionality. For example, the software architecture 702 may include layers such as an operating system 714, libraries 716, frameworks/middleware 718, applications 720 and presentation layer 744. Operationally, the applications 720 and/or other components within the layers may invoke application programming interface (API) calls 724 through the software stack and access a response, returned values, and so forth illustrated as messages 726 in response to the API calls 724. The layers illustrated are representative in nature and not all software architectures have all layers. For example, some mobile or special purpose operating systems may not provide a frameworks/middleware layer 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the architecture 702 to pause its current processing and execute an interrupt service routine (ISR) when an interrupt is accessed.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers). Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 716 may also include a wide variety of other libraries 738, such as machine learning libraries, to provide many other APIs to the applications 720 and other software components/modules.

The frameworks 718 (also sometimes referred to as middleware) may provide a higher-level common infrastructure that may be utilized by the applications 720 and/or other software components/modules. For example, the frameworks 718 may provide various graphic user interface (GUI) functions, high-level resource management, high-level location services, and so forth. The frameworks 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any of the built in applications as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™ Windows® Phone, or other mobile computing device operating systems. In this example, the third-party application 742 may invoke the API calls 724 provided by the mobile operating system such as operating system 714 to facilitate functionality described herein.

The applications 720 may utilize built in operating system functions (e.g., kernel 728, services 730 and/or drivers 732), libraries (e.g., system 734, APIs 736, and other libraries 738), frameworks/middleware 718 to create user interfaces to interact with users of the system. Alternatively, or additionally, in some systems interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine as well as the interface with the host operating system (i.e., operating system 714). A software architecture executes within the virtual machine 748 such as an operating system 750, libraries 752, frameworks/middleware 754, applications 756 and/or presentation layer 758. These layers of software architecture executing within the virtual machine 748 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier. e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

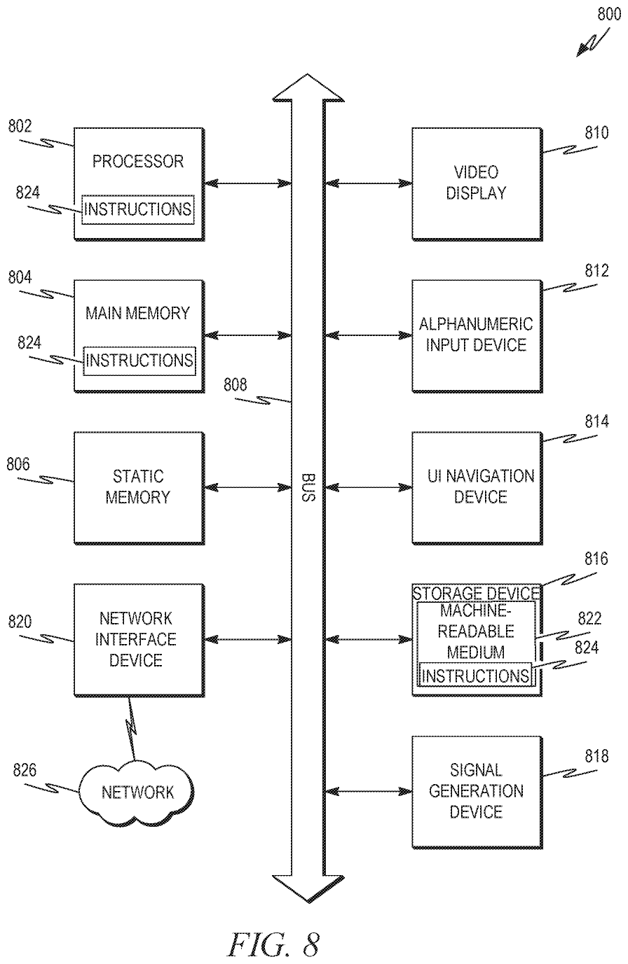

FIG. 8 is a block diagram of a machine in the example form of a computer system 800 within which instructions 824 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation (or cursor control) device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, with the main memory 804 and the processor 802 also constituting machine-readable media 822.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks, and CD-ROM and DVD-ROM disks. A machine-readable medium is not a transmission medium.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for obscuring personal information in a sensor data stream, the system comprising:
a computing device comprising at least one processor and an associated storage device, the at least one processor programmed to perform operations comprising:
applying an encoder model to the sensor data stream to generate a latent space representation of the sensor data stream;
applying a noise-scaling parameter to the latent space representation of the sensor data stream; and
applying a decoder model to the latent space representation of the sensor data stream to generate an obscured data stream.

2. The system of claim 1, wherein the noise-scaling parameter is a parameter of the decoder model.

3. The system of claim 1, wherein the latent space representation of the sensor data stream comprises a state vector, the state vector describing a mean and a variance.

4. The system of claim 3, wherein the noise-scaling parameter comprises a scalar, and wherein applying the noise-scaling parameter to the latent space representation of the sensor data stream comprises applying the scalar to the state vector.

5. The system of claim 3, the operations further comprising sampling a distribution having with a mean equal to the mean of the state vector and a variance that is a function of the variance of the state vector and the noise-scaling parameter, the sampling to generate a sampled data stream, wherein an input to the decoder model is based at least in part on the sampled data stream.

6. The system of claim 1, the operations further comprising training the encoder model and the decoder model using a training data set and a loss function.

7. The system of claim 6, the operations further comprising:
accessing maximum-mean discrepancy (MMD) data describing a maximum-mean discrepancy between the latent space representation of the sensor data stream and a desired latent distribution of the sensor data stream, and
determining the loss function using the MMD data and the latent space representation of the sensor data stream.

8. The system of claim 6, the operations further comprising:
accessing Kullback-Leibler data describing a Kullback-Leibler divergence between the latent space representation of the sensor data stream and a desired latent distribution of the sensor data stream; and
determining the loss function using the Kullback-Leibler data and the latent space representation of the sensor data stream.

9. The system of claim 1, further comprising a Fourier transform layer, and wherein the latent space representation of the sensor data stream is based at least in part on a frequency-domain representation of the sensor data stream.

10. A method for obscuring personal information in a sensor data stream, the method comprising:
applying, using at least one processor, an encoder model to the sensor data stream to generate a latent space representation of the sensor data stream;
applying, using the at least one processor, a noise-scaling parameter to the latent space representation of the sensor data stream; and
applying, using the at least one processor, a decoder model to the latent space representation of the sensor data stream to generate an obscured data stream.

11. The method of claim 10, wherein the noise-scaling parameter is a parameter of an autoencoder model comprising the encoder model the decoder model.

12. The method of claim 10, wherein the latent space representation of the sensor data stream comprises a state vector, the state vector describing a mean and a variance.

13. The method of claim 12, wherein the noise-scaling parameter comprises a scalar, and wherein applying the noise-scaling parameter to the latent space representation of the sensor data stream comprises applying the scalar to the state vector.

14. The method of claim 12, further comprising sampling a distribution having with a mean equal to the mean of the state vector and a variance that is a function of the variance of the state vector and the noise-scaling parameter, the sampling to generate a sampled data stream, wherein an input to the decoder model is based at least in part on the sampled data stream.

15. The method of claim 10, further comprising training the encoder model and the decoder model using a training data set and a loss function.

16. The method of claim 15, further comprising:
accessing maximum-mean discrepancy (MMD) data describing a maximum-mean discrepancy between the latent space representation of the sensor data stream and a desired latent distribution of the sensor data stream, and
determining the loss function using the MMD data and the latent space representation of the sensor data stream.

17. The method of claim 16, further comprising:
accessing Kullback-Leibler data describing a Kullback-Leibler divergence between the latent space representation of the sensor data stream and a desired latent distribution of the sensor data stream; and
determining the loss function using the Kullback-Leibler data and the latent space representation of the sensor data stream.

18. The method of claim 10, further comprising applying a Fourier transform to the sensor data stream, and wherein the latent space representation of the sensor data stream is based at least in part on a frequency-domain representation of the sensor data stream.

19. A non-transitory machine-readable medium comprising instructions thereon that, when executed by at least one processor, causes the at least one processor to perform operations comprising:
applying an encoder model to a sensor data stream to generate a latent space representation of the sensor data stream;
applying a noise-scaling parameter to the latent space representation of the sensor data stream; and
applying a decoder model to the latent space representation of the sensor data stream to generate an obscured data stream.

20. The medium of claim 19, wherein the noise-scaling parameter is a parameter of an autoencoder model comprising the encoder model and the decoder model.
